(19) United States
(12) Patent Application Publication
(10) Pub. No.: US 2016/0061048 A1
(43) Pub. Date: Mar. 3, 2016

(54) ROTOR BLADE WITH L-SHAPED FEATHER SEAL

(71) Applicant: UNITED TECHNOLOGIES CORPORATION, Hartford, CT (US)

(72) Inventors: Christopher Corcoran, East Hartford, CT (US); Anthony P. Cherolis, Hartford, CT (US)

(21) Appl. No.: 14/779,841

(22) PCT Filed: Mar. 24, 2014
(86) PCT No.: PCT/US2014/031581

§ 371 Date: Sep. 24, 2015

Related U.S. Application Data
(60) Provisional application No. 61/804,955, filed on Mar. 25, 2013.

(51) Int. Cl. F01D 11/00; F01D 5/14; F01D 15/12; F01D 5/02

(52) U.S. Cl. CPC F01D 11/008; F01D 5/02; F01D 5/147; F01D 15/12; F05D 2220/30; F05D 2240/30; F05D 2240/55; F05D 2260/97

(57) ABSTRACT

A turbine engine assembly arranged relative to an axis includes a rotor blade and a feather seal with an L-shaped geometry. The rotor blade includes an airfoil and a base. The airfoil extends axially between an upstream leading edge and a downstream trailing edge, and radially out from the base. The base includes a neck and a pocket. The neck extends axially to a downstream surface. The pocket extends laterally into the neck. The feather seal extends laterally into the pocket, and includes a down stream leg that extends substantially along the downstream surface.

### CROSS-REFERENCE TO RELATED APPLICATIONS

This application claims priority to U.S. Provisional Patent Appln. No. 61/804,955 filed Mar. 25, 2013, which is hereby incorporated herein by reference in its entirety.

### BACKGROUND OF THE INVENTION

1. Technical Field

This disclosure relates generally to a turbine engine and, more particularly, to a feather seal for sealing a gap between adjacent rotor blades.

2. Background Information

A turbine rotor assembly for a turbine engine typically includes a plurality of turbine blades arranged circumferentially around and attached to a rotor disk. The rotor assembly may also include a plurality of feather seals. Each feather seal is respectively arranged between and extends into opposing pockets of an adjacent pair of the turbine blades. Each feather seal may at least partially seal a gap that extends between the adjacent turbine blades. Each feather seal may each have a substantially planar geometry, or a U-shaped geometry.

There is a need in the art for a rotor assembly with an improved feather seal.

### SUMMARY OF THE DISCLOSURE

According to an aspect of the invention, a turbine engine assembly is provided that is arranged relative to an axis. The assembly includes a rotor blade and a feather seal with an L-shaped geometry. The rotor blade includes an airfoil and a base. The airfoil extends axially between an upstream leading edge and a downstream trailing edge, and radially out from the base. The base includes a neck and a pocket. The neck extends axially to a downstream surface. The pocket extends laterally into the neck. The feather seal extends laterally into the pocket, and includes a downstream leg that extends substantially along the downstream surface.

According to another aspect of the invention, another turbine engine assembly is provided that is arranged relative to an axis. The assembly includes a feather seal and a rotor blade with an airfoil and a base. The airfoil extends axially between an upstream leading edge and a downstream trailing edge, and radially out from the base. The base includes a platform, a neck and a pocket. The platform is arranged radially between the airfoil and the neck, and includes a gas path surface. The pocket extends laterally into the neck. The feather seal includes an upstream leg and a downstream leg. The upstream leg extends substantially along the gas path surface. The downstream leg has a chord that is angled between about seventy five degrees and about eighty five degrees relative to a chord of the upstream leg.

The feather seal may have an L-shaped geometry.

The neck may extend axially to a downstream surface. The downstream leg may extend substantially along the downstream surface.

The feather seal may include an upstream leg. The upstream leg may have a chord that is angled between about seventy-five degrees and about eighty-five degrees relative to a chord of the downstream leg.

The base may include a platform arranged radially between the neck and the airfoil. The platform may include a gas path surface. The upstream leg may extend substantially along the gas path surface.

The upstream leg may substantially follow a contour of the gas path surface.

The upstream leg may extend to an upstream end of the feather seal. The downstream leg may also or alternatively extend to a downstream end of the feather seal.

The upstream leg may include a first portion with a substantially planar geometry, and a second portion with an arcuate geometry. The second portion may be arranged between the first portion and the downstream leg. The downstream leg may also or alternatively have a substantially planar geometry.

The downstream leg may have a chord that is angled between zero and about fifteen degrees relative to a chord of the downstream surface.

The feather seal may extend from an upstream end to a downstream end. The base may include a plurality of bumpers that laterally locate the feather seal within the pocket. A first of the bumpers may be located at the upstream end. A second of the bumpers may also or alternatively be located at the downstream end. A third of the bumpers may also or alternatively be located at a corner of the feather seal.

The base may include a platform arranged radially between the neck and the airfoil, and a retainer that radially locates the feather seal within the pocket. The feather seal may be arranged radially between the platform and the retainer.

The retainer may be configured as or otherwise include a first retainer. The base may also include a second retainer that radially locates the feather seal within the pocket. The first retainer may be located at an upstream end of the feather seal. The second retainer may be located at a corner of the feather seal. The feather seal may be arranged radially between the platform and the second retainer.

The retainer may be configured as or otherwise include a first retainer. The base may also include a second retainer that axially locates the feather seal within the pocket. The second retainer may be located at a downstream end of the feather seal. The feather seal may be arranged axially between the second retainer and a downstream portion of the neck.

The assembly may include a second rotor blade with a second pocket. The feather seal may extend laterally into the second pocket.

The assembly may include a shaft and a plurality of engine rotors arranged along the axis. The engine rotors may include a first rotor and a second rotor. One of the engine rotors may include the rotor blade, the second rotor blade and the feather seal. The first rotor may be driven by and connected to the second rotor through the shaft.

The assembly may include a gear train that connects the first rotor to the shaft.

The foregoing features and the operation of the invention will become more apparent in light of the following description and the accompanying drawings.

### BRIEF DESCRIPTION OF THE DRAWINGS

FIG. 1 is a side cutaway illustration of a geared turbine engine;

FIG. 2 is a cross-sectional illustration of a rotor assembly for the engine of FIG. 1;

FIG. 3 is a partial side illustration of a rotor blade and a feather seal for the rotor assembly of FIG. 2;

FIG. 4 is an enlarged portion of the rotor assembly of FIG. 2;

FIG. 5 is a cross-sectional illustration of the rotor blade and feather seal of FIG. 3;

FIG. 6 is partial side illustration of a portion of a rotor blade and a feather seal;

FIG. 7 is a partial side illustration of a rotor blade and a feather seal for the rotor assembly of FIG. 2 during engine operation;

FIG. 8 is an enlarged portion of the rotor assembly of FIG. 2 during engine operation; and

FIG. 9 is a partial side illustration of another rotor blade and a feather seal for the rotor assembly of FIG. 2.

### DETAILED DESCRIPTION OF THE INVENTION

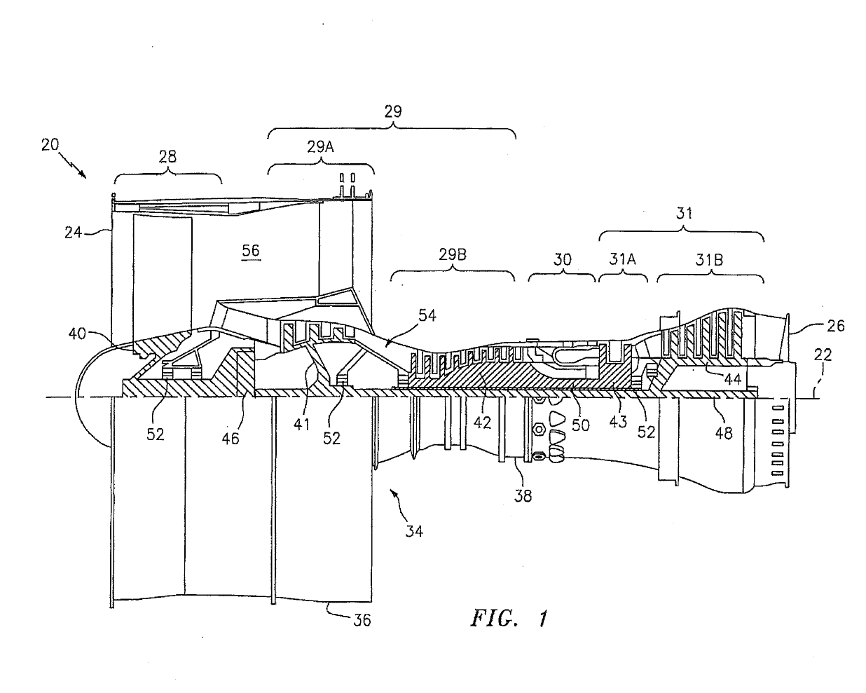

FIG. 1 is a side cutaway illustration of a geared turbine engine 20 that extends along an axis 22 between an upstream airflow inlet 24 and a downstream airflow exhaust 26. The engine 20 includes a fan section 28, a compressor section 29, a combustor section 30 and a turbine section 31. The compressor section 29 includes a low pressure compressor (LPC) section 29A and a high pressure compressor (HPC) section 29B. The turbine section 31 includes a high pressure turbine (HPT) section 31A and a low pressure turbine (LPT) section 31B. The engine sections 28-31 are arranged sequentially along the axis 22 within an engine housing 34, which includes a first engine case 36 (e.g., a fan nacelle) and a second engine case 38 (e.g., a core nacelle).

Each of the engine sections 28, 29A, 29B, 31A and 31B includes a respective rotor 40-44. The fan rotor 40 is connected (e.g., mechanically fastened, welded, brazed, adhered or otherwise bonded) to a gear train 46; e.g., an epicyclic gear train. The gear train 46 and the LPC rotor 41 are connected to and driven by the LPT rotor 44 through a low speed shaft 48. The HPC rotor 42 is connected to and driven by the HPT rotor 43 through a high speed shaft 50. The low and high speed shafts 48 and 50 are rotatably supported by a plurality of bearings 52. Each of the bearings 52 is connected to the second engine case 38 by at least one stator such as, for example, an annular support strut.

Air enters the engine 20 through the airflow inlet 24, and is directed through the fan section 28 and into an annular core gas path 54 and an annular bypass gas path 56. The air within the core gas path 54 may be referred to as “core air”. The air within the bypass gas path 56 may be referred to as “bypass air”. The core air is directed through the engine sections 29-31 and exits the engine 20 through the airflow exhaust 26. Within the combustor section 30, fuel is injected into and mixed with the core air and ignited to provide forward engine thrust. The bypass air is directed through the bypass gas path 56 and out of the engine 20 to provide additional forward engine thrust, or reverse thrust via a thrust reverser.

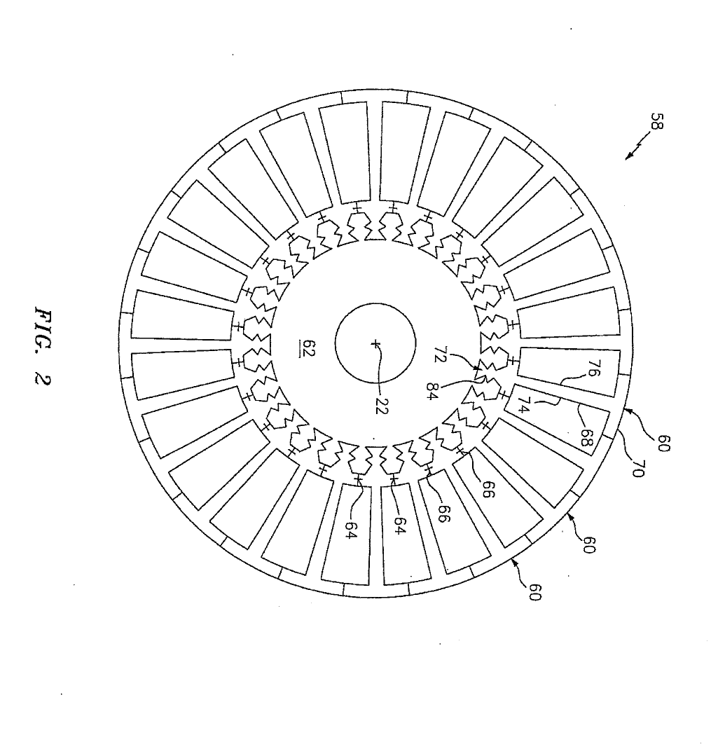

FIG. 2 is a cross-sectional illustration of a rotor assembly 58 included in the LPT rotor 44 of FIG. 1. The rotor assembly 58 includes one or more rotor blades 60 (e.g., turbine blades) arranged circumferentially around a rotor disk 62. The rotor assembly 58 also includes one or more feather seals 64. Each of the feather seals 64 at least partially seals a gap 66 between an adjacent pair of the rotor blades 60.

One or more of the rotor blades 60 each includes an airfoil 68, a shroud 70 and a base 72. The airfoil 68, the shroud 70 and the base 72 may be machined, cast, milled and/or otherwise formed integral with one another. The respective rotor blade 60 may therefore be configured as a unitary body.

The airfoil 68 extends radially out from the base 72 to the shroud 70. The airfoil 68 extends laterally (e.g., circumferentially or tangentially) between an airfoil concave surface 74 (e.g., a pressure side surface) and an airfoil convex surface 76 (e.g., a suction side surface). Referring to FIG. 3, the airfoil 68 extends axially between an upstream leading edge 78 and a downstream trailing edge 80.

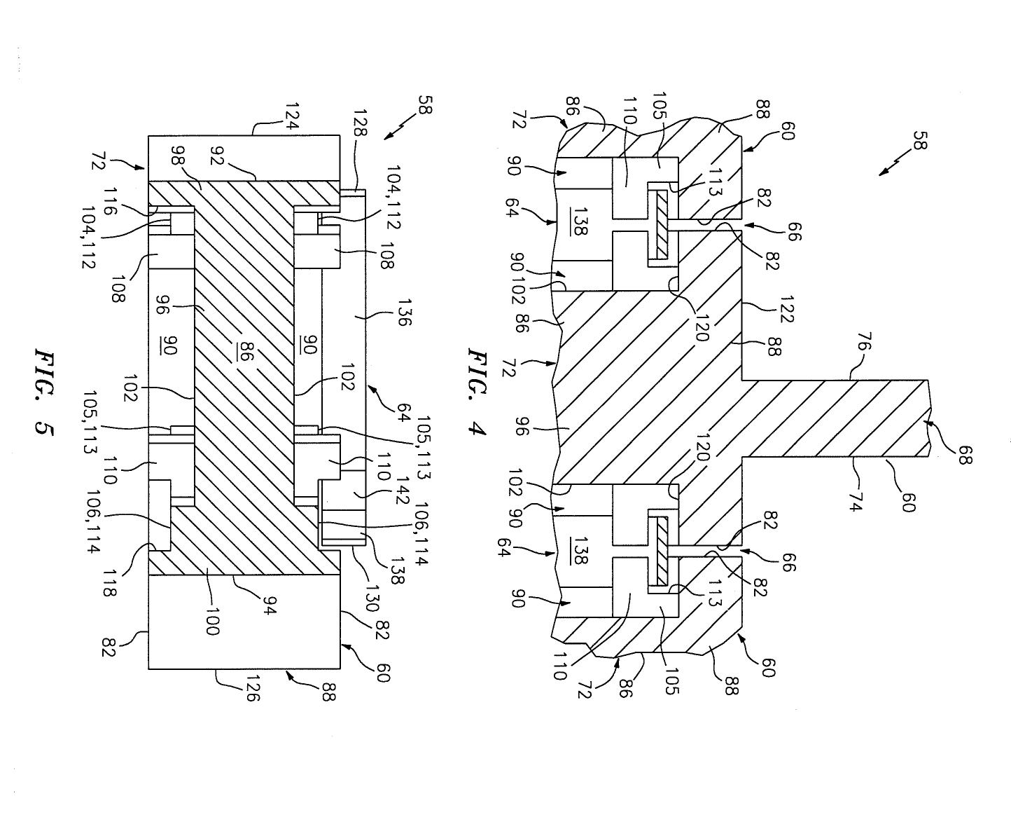

Referring to FIGS. 3 to 5, the base 72 extends laterally between opposing base side surfaces 82. The base 72 includes a root 84, a neck 86, a platform 88, and one or more pockets 90. Referring to FIG. 2, the root 84 attaches the respective rotor blade 60 to the rotor disk 62. The root 84 may have a fir tree configuration.

Referring to FIGS. 3 to 5, the neck 86 is arranged and extends radially between the root 84 and the platform 88. The neck 86 extends laterally between the side surfaces 82. The neck 86 extends axially from a neck upstream end surface 92 and/or the platform 88 to a neck downstream end surface 94. The neck 86 includes an intermediate portion 96 (e.g., a web), an upstream portion 98 (e.g., a flange) and a downstream portion 100 (e.g., a flange).

The intermediate portion 96 is arranged and extends axially between the upstream portion 98 and the downstream portion 100. The intermediate portion 96 includes one or more pocket end surfaces 102, one or more bumpers 104-106, and/or one or more retainers 108 and 110 (e.g., tabs). One or more of the bumpers 104-106 each extends laterally from a respective one of the pocket end surfaces 102 to a respective bumper surface 112-114 (e.g., a shelf). Each bumper surface 112-114 is laterally recessed from a respective one of the side surfaces 82. One or more of the retainers 108 and 110 each extends laterally from a respective one of the bumpers 104 and 105 (or the pocket end surface 102) to a respective one of the side surfaces 82. Alternatively, one or more of the retainers may each extend to a surface that is laterally recessed from the respective side surface 82.

The upstream portion 98 extends laterally between the side surfaces 82. The upstream portion 98 is arranged and extends axially from the upstream end surface 92 to the intermediate portion 96 and one or more upstream pocket side surfaces 116.

The downstream portion 100 extends laterally between the side surfaces 82. The downstream portion 100 is arranged and extends axially from the intermediate portion 96 and one or more downstream pocket side surfaces 118 to the downstream end surface 94.

The platform 88 extends radially from the neck 86 and one or more outer pocket side surfaces 120 to a gas path surface 122. The airfoil 68 extends radially out from the gas path surface 122, which defines a portion of an inner surface of the core gas path 54 (see FIG. 1). The platform 88 extends laterally between the side surfaces 82. The platform 88 extends axially between a platform upstream end 124 and a platform downstream end 126. The platform 88 may also project axially out from the neck 86. The neck upstream end surface 92, for example, is axially recessed from the platform upstream end 124. The neck downstream end surface 94 is axially recessed from the platform downstream end 126.

One or more of the pockets 90 each extends laterally into the base 72 from a respective one of the side surfaces 82 to a respective one of the pocket end surfaces 102. One or more of the pockets 90 each extends radially through the base 72 to a respective one of the outer pocket side surfaces 120. One or more of the pockets 90 each extends axially within the base 72 between a respective one of the upstream pocket side surfaces 116 and a respective one of the downstream pocket side surfaces 118. Referring to FIG. 3, one or more of the pockets 90 may each have a polygonal (e.g., generally trapezoidal or triangular) cross-sectional geometry.

One or more of the feather seals 64 each have a generally L-shaped geometry. One or more of the feather seals 64 each extends longitudinally from a seal upstream end 128 to a seal downstream end 130. One or more of the feather seals 64 each has a thickness that extends (e.g., radially and/or axially) between an inner seal surface 132 and an outer seal surface 134.

One or more of the feather seals 64 each includes an upstream leg 136 and a downstream leg 138. The upstream leg 136 and the downstream leg 138 are connected together at a corner 140, for example, by an arcuate corner portion 142. Alternatively, the upstream leg 136 may be directly connected to the downstream leg 138 at the corner 140. The upstream leg 136, the downstream leg 138 and the corner portion 142 may be machined, cast, milled and/or otherwise formed integral with one another. The respective feather seal 64 may therefore be configured as a unitary body.

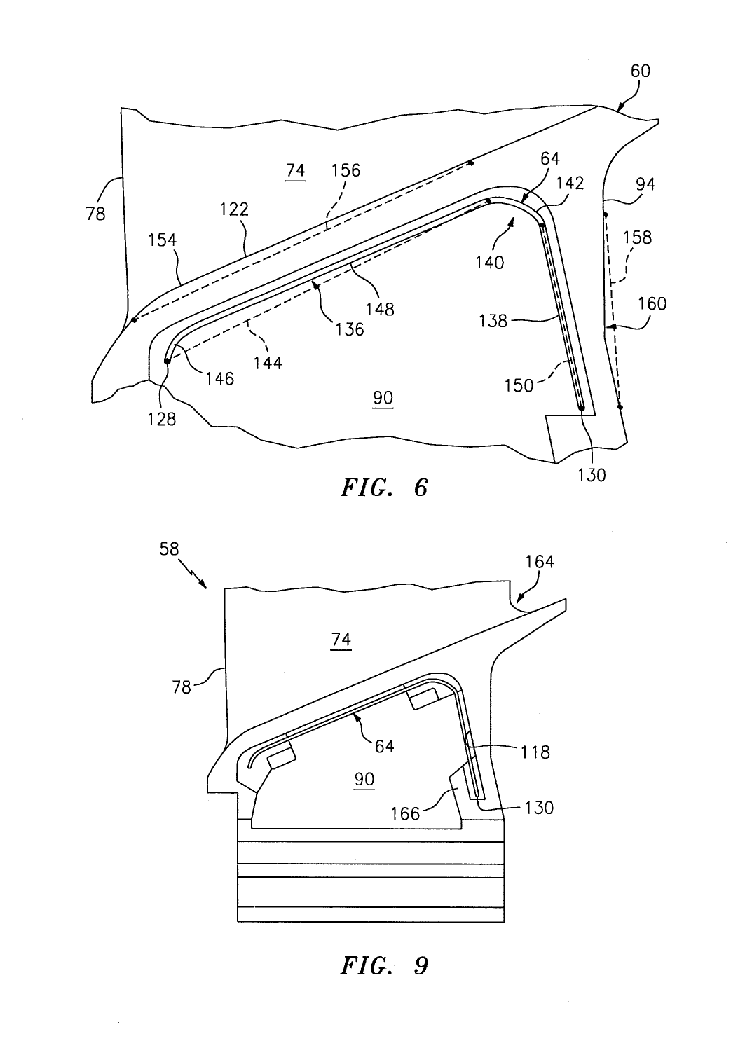

Referring to FIG. 6, the upstream leg 136 has a longitudinal chord 144. The chord 144 extends between the upstream end 128 and an intersection of the upstream leg 136 and the corner portion 142. The upstream leg 136 includes a first portion 146 with an arcuate geometry, and a second portion 148 with a substantially planar geometry. The first portion 146 extends longitudinally from the upstream end 128 to the second portion 148. The second portion 148 extends longitudinally from the first portion 146 to the corner portion 142. The second portion 148 therefore is arranged between the first portion 146 and the downstream leg 138.

The downstream leg 138 has a longitudinal chord 150. The chord 150 extends between an intersection of the downstream leg 138 and the corner portion 142 and the downstream end 130. The chord 150 is angled relative to the chord 144 by an offset angle of between about seventy-five degrees (75°) and about eighty-five degrees (85°). The downstream leg 138 extends longitudinally from the corner portion 142 to the downstream end 130. The downstream leg 138 may have a substantially planar geometry.

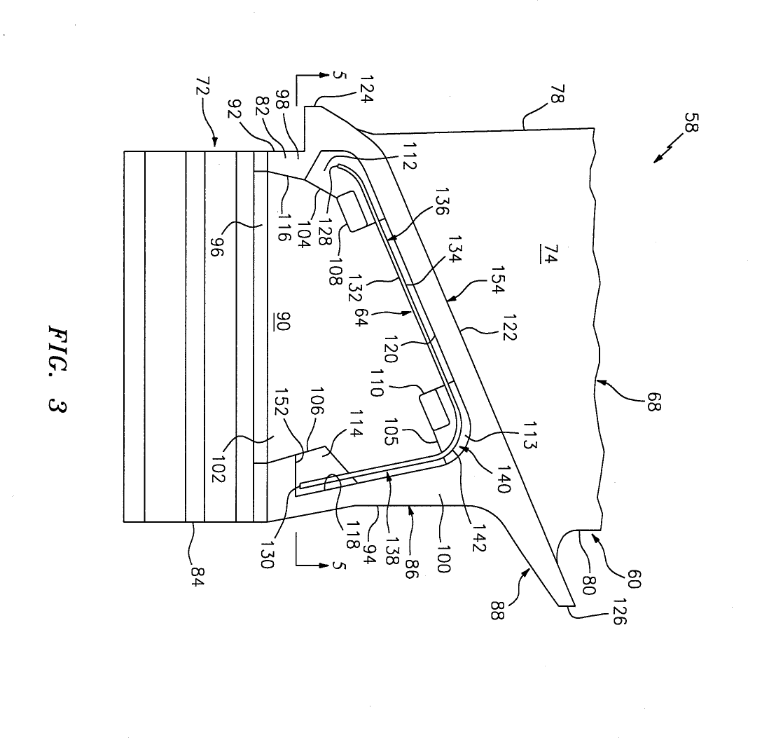

Referring to FIG. 4, each of the feather seals 64 is arranged between an adjacent pair of the rotor blades 60. Referring to FIGS. 3 and 4, each of the feather seals 64 extends laterally into the respective pockets 90. The upstream leg 136 is arranged radially between retainers 108 and 110 and the outer pocket surface 120. The retainer 108 is located at (e.g., on, adjacent or proximate) the seal upstream end 128. The retainer 110 is located at the corner 140. In this manner, the retainers 108 and 110 and/or a surface 152 of the downstream portion 100 of the neck 86 radially locate the respective feather seal 64 within the respective pockets 90. The retainers 110 may also or alternatively axially locate the respective feather seal 64 within the respective pockets 90.

One or more of the feather seals 64 are each arranged proximate to or engages (e.g., contacts) one or more of the respective bumper surfaces 112-114. The bumper 104 is located at the seal upstream end 128. The bumper 105 is located at the corner 140. The bumper 106 is located at the seal downstream end 130. In this manner, the bumpers 104-106 laterally locate the respective feather seal 64 within the respective pockets 90.

Referring to FIG. 6, the upstream leg 136 extends longitudinally substantially along each respective gas path surface 122. The upstream leg 136, for example, substantially follows a side-sectional contour of a portion 154 of the gas path surface 122 that is axially aligned with the upstream leg 136. The chord 144 may also or alternatively be angled relative to a chord 156 of the portion 154 by an offset angle of between about zero degrees (0°) and about five degrees (5°).

The downstream leg 138 extends longitudinally substantially along each respective neck downstream end surface 94. For example, the chord 150 is angled relative to a chord 158 of a portion 160 of the neck downstream end surface 94, which is radially aligned with the downstream leg 138, by an offset angle of between zero degrees (0°) and about fifteen degrees (15°). The downstream leg 138 may also or alternatively substantially follow a side-sectional contour of the portion 150 (not shown).

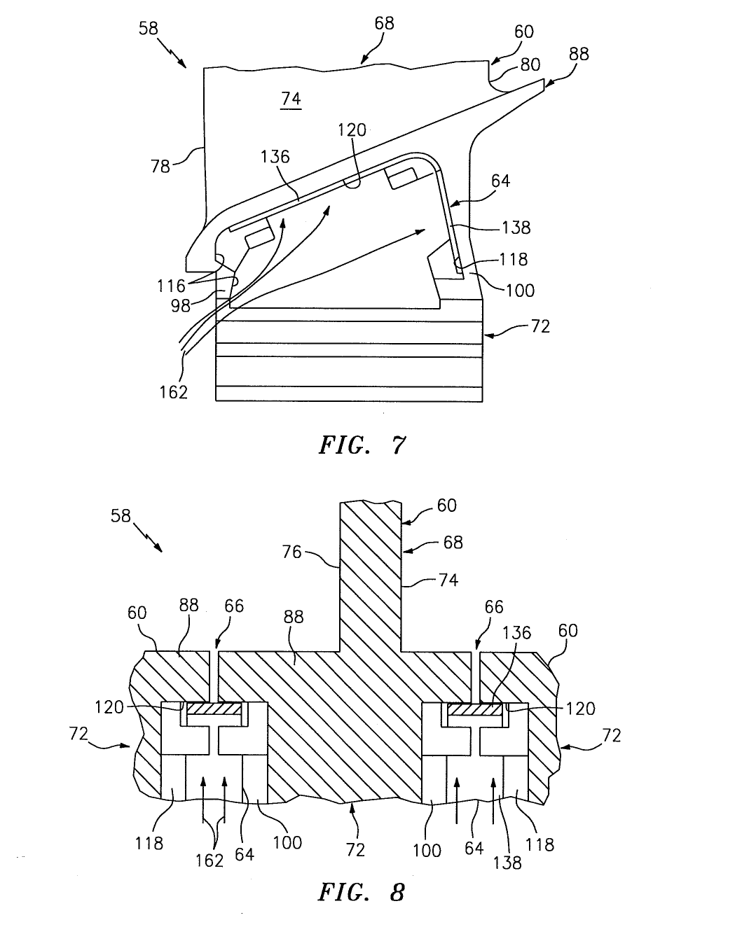

Referring to FIGS. 7 and 8, a centrifugal force induced by rotation of the rotor disk 62 (see FIG. 2) may force each of the feather seals 64 against the respective outer pocket side surfaces 120 and/or the respective downstream pocket side surfaces 118. The upstream leg 136 may radially engage and form a seal with the platforms 88 of the respective adjacent rotor blades 60. The downstream leg 138 may axially engage and form a seal with the downstream portions 100 of the respective adjacent rotor blades 60. In this manner, each feather seal 64 may reduce or prevent axially and/or radially flowing purge air 162 (e.g., cooling air) from leaking through the gap 66 between the respective adjacent rotor blades 60.

In addition to reducing or preventing air leakage through the gaps 66, the feather seals 64 enable material from the upstream pocket side surfaces 116 to be removed during balancing of the rotor assembly 58. The rotor blades 60 and, more particularly, the bases 72 may also be configured with relatively thin upstream portions 98, which may reduce the overall weight of the rotor blades 60 and the rotor assembly 58.

FIG. 9 is a partial side illustration of the feather seal 64 mated with another rotor blade 164. In contrast to the rotor blade 60 of FIG. 3, the rotor blade 164 includes an additional retainer 166 located at the seal downstream end 130. The feather seal 64 is arranged axially between the retainer 166 and the downstream pocket side surface 118. In this manner, the retainer 164 may axially locate the feather seal 64 within the pocket 90.

One or more rotor blades 60 may have various configurations other than those described above and illustrated in the drawings. For example, one or more of the rotor blades may each be configured without the shroud 70. In such an embodiment, a tip of each respective rotor blade may engage an annular blade outer air seal (BOAS). One or more of the rotor blades may each be configured without one or more of the bumpers where, for example, the feather seal is located by the pocket end surfaces. One or more of the rotor blades may be configured without one or more of the retainers where, for example, the pockets are configured as slots. The present invention therefore is not limited to any particular rotor blade configurations.

One or more of the feather seals 64 may have various configurations other than those described above and illustrated in the drawings. For example, one or more of the feather seals may each be configured without the first portion such that the upstream leg has a substantially planar geometry. Alternatively, the second portion or the entire upstream leg may have an arcuate geometry or any other geometry. The downstream portion of one or more of the feather seals may each be configured with an arcuate geometry or any other geometry. The present invention therefore is not limited to any particular feather seal configurations.

The rotor assembly 58 may be included in rotors other than the LPT rotor 44 as described above. For example, one or more of the rotors 40-47 may also or alternatively each include one or more of the rotor assemblies 58.

The terms “upstream”, “downstream”, “inner” and “outer” are used to orientate the components of the rotor assembly 58 described above relative to the turbine engine and its axis. A person of skill in the art will recognize, however, one or more of these components may be utilized in other orientations than those described above. The present invention therefore is not limited to any particular rotor assembly spatial orientations.

A person of skill in the art will recognize the rotor assembly 58 may be included in various turbine engines other than the one described above. The rotor assembly, for example, may be included in a geared turbine engine where a gear train connects one or more shafts to one or more rotors in a fan section, a compressor section and/or any other engine section. Alternatively, the rotor assembly may be included in a turbine engine configured without a gear train. The rotor assembly may be included in a geared or non-geared turbine engine configured with a single spool, with two spools (e.g., see FIG. 1), or with more than two spools. The turbine engine may be configured as a turbofan engine, a turbojet engine, a propfan engine, or any other type of turbine engine. The present invention therefore is not limited to any particular types or configurations of turbine engines.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined within any one of the aspects and remain within the scope of the invention. Accordingly, the present invention is not to be restricted except in light of the attached claims and their equivalents.

What is claimed is:

1. A turbine engine assembly arranged relative to an axis, the assembly comprising:
a rotor blade including an airfoil and a base;
the airfoil extending axially between an upstream leading edge and a downstream trailing edge, and radially out from the base; and
the base including a neck and a pocket, the neck extending axially to a downstream surface, and the pocket extending laterally into the neck; and
a feather seal with an L-shaped geometry, the feather seal extending laterally into the pocket, and including a downstream leg that extends substantially along the downstream surface.

2. The assembly of claim 1, wherein the downstream leg has a chord that is angled between zero and about fifteen degrees relative to a chord of the downstream surface.

3. The assembly of claim 1, wherein the downstream leg extends to a downstream end of the feather seal.

4. The assembly of claim 1, wherein the downstream leg has a substantially planar geometry.

5. The assembly of claim 1, wherein
the feather seal further includes an upstream leg; and
the upstream leg has a chord that is angled between about seventy-five degrees and about eighty-five degrees relative to a chord of the downstream leg.

6. The assembly of claim 5, wherein
the base further includes a platform arranged radially between the neck and the airfoil;
the platform includes a gas path surface; and
the upstream leg extends substantially along the gas path surface.

7. The assembly of claim 6, wherein the upstream leg substantially follows a contour of the gas path surface.

8. The assembly of claim 5, wherein the upstream leg extends to an upstream end of the feather seal.

9. The assembly of claim 8, wherein the upstream leg includes a first portion with a substantially planar geometry and a second portion with an arcuate geometry, and the second portion is arranged between the first portion and the downstream leg.

10. The assembly of claim 1, wherein
the feather seal extends from an upstream end to a downstream end;
the base further includes a plurality of bumpers that laterally locate the feather seal within the pocket; and
a first of the bumpers is located at the upstream end, and a second of the bumpers is located at the downstream end.

11. The assembly of claim 10, wherein a third of the bumpers is located at a corner of the feather seal.

12. The assembly of claim 1, wherein
the base further includes a platform arranged radially between the neck and the airfoil, and a retainer that radially locates the feather seal within the pocket; and
the feather seal is arranged radially between the platform and the retainer.

13. The assembly of claim 12, wherein
the retainer comprises a first retainer, and the base further includes a second retainer that radially locates the feather seal within the pocket;
the first retainer is located at an upstream end of the feather seal, and the second retainer is located at a corner of the feather seal; and
the feather seal is arranged radially between the platform and the second retainer.

14. The assembly of claim 12, wherein
the retainer comprises a first retainer, and the base further includes a second retainer that axially locates the feather seal within the pocket;
the second retainer is located at a downstream end of the feather seal; and
the feather seal is arranged axially between the second retainer and a downstream portion of the neck.

15. The assembly of claim 1, further comprising:
a second rotor blade including a second pocket;
wherein the feather seal further extends laterally into the second pocket.

16. The assembly of claim 15, further comprising:
a shaft; and
a plurality of engine rotors arranged along the axis and including a first rotor and a second rotor, one of the engine rotors including the rotor blade, the second rotor blade and the feather seal;
wherein the first rotor is driven by and connected to the second rotor through the shaft.

17. The assembly of claim 16, further comprising a gear train that connects the first rotor to the shaft.

18. A turbine engine assembly, comprising:
a rotor blade including an airfoil and a base;
the airfoil extending axially between an upstream leading edge and a downstream trailing edge, and radially out from the base; and
the base including a platform, a neck and a pocket, wherein platform is arranged radially between the airfoil and the neck and includes a gas path surface, and the pocket extends laterally into the neck; and
a feather seal including an upstream leg and a downstream leg;
the upstream leg extending substantially along the gas path surface; and
the downstream leg having a chord that is angled between about seventy-five degrees and about eighty-five degrees relative to a chord of the upstream leg.

19. The assembly of claim 18, wherein the feather seal has an L-shaped geometry.

20. The assembly of claim 18, wherein
the neck extends axially to a downstream surface; and
the downstream leg extends substantially along the downstream surface.
